(19) United States
(12) Patent Application Publication
(10) Pub. No.: US 2013/0324309 A1
(43) Pub. Date: Dec. 5, 2013

(54) High Intensity Visible Light Curable Ink For A Game Ball And Other Substrates And Method Of Printing

(71) Applicant: Thomas J. Kennedy, III, Wilbraham, MA (US)

(72) Inventor: Thomas J. Kennedy, III, Wilbraham, MA (US)

(73) Assignee: NIKE, Inc., Beaverton, OR (US)

(21) Appl. No.: 13/483,447

(22) Filed: May 30, 2012

(51) Int. Cl. A63B 37/00; A63B 43/00; B05D 3/06; B32B 33/00

(52) U.S. Cl. 473/351; 428/195.1; 473/569; 427/511

(57) ABSTRACT

An ink that is curable with high intensity visible light. Also, substrates, particularly game balls, printed with such ink, and a method for printing.

### BACKGROUND

The present disclosure generally relates to inks, and more particularly to inks curable with visible light. The disclosure also relates to substrates, particularly game balls, onto which the ink is printed and cured.

Inks curable with visible light are quick-curing inks and therefore are advantageous for use in continuous-type processes in which subsequent treatment of an ink-printed substrate is involved. A number of UV-curable inks are known. One such known ink comprises a photopolymerizable ink composition containing acrylate resin, methacrylate monomer or oligomer, acrylate monomer or oligomer, photoinitiator, and a particular type of an epoxy resin. UV-curable ink having an isocyanate compound added thereto is said to be particularly well suited for printing on slightly adhesive plastic bases, such as those made of polyoxymethylenes and polypropylenes. UV-curable ink for applying indicia to a game ball also is known. Curing with UV light is less than satisfactory, as the cost of bulbs is high and operation is energy-intensive. Further, ozone typically is generated, thus presenting a potential regulatory issue.

Inks curable with visible light that can be pad printed and cured with only a visible-light activated photoinitiator have not been utilized on golf balls.

Screen printing on spherical surfaces such as golf balls can be difficult. As a result, pad printing customarily is used for marking golf ball surfaces. However, many of the known inks are not well suited for pad printing because it is difficult to transfer the ink from a pad to a substrate.

Therefore, there exists a need for a highly durable ink curable with visible light which has favorable pad transfer properties when used for printing indicia on surfaces such as a curved and dimpled surface of a golf ball, and which provides an image having good durability.

### SUMMARY

An aspect of the disclosure is to provide an ink curable with visible light which is particularly well suited for application by pad transfer.

Another aspect of the disclosure is to provide a visible light curable ink that uses only visible-light activated photoinitiator and no co-initiator.

A further aspect of the disclosure is to provide a quick curing ink for use on a game ball, such as golf ball, thereby enabling more rapid production.

Another aspect of the disclosure is to provide a pad-printable ink cured with visible light and having good impact resistance.

Yet another aspect of the disclosure is to provide a game ball, such as a golf ball, having a clear and durable ink image printed thereon.

Still another aspect of the disclosure is to provide a method of printing and curing an ink cured with visible light on a substrate.

Other systems, methods, features, and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 illustrates a cut-away view of a game ball having an indicium comprising an ink cured with visible light in accordance with embodiments of the present disclosure; and

FIG. 2 is a view of the surface of a game ball having an indicium comprising an ink cured with visible light in accordance with embodiments of the present disclosure; and

FIG. 3 illustrates a schematic flow chart of a method in accordance with embodiments of the disclosure.

### DETAILED DESCRIPTION

Generally, this disclosure relates to an ink curable with visible light. The curing is quick, and the ink is suited for application by pad transfer. Also, the cured ink has good impact resistance, making it suitable for use on items in rough service, such as game balls and implements. In embodiments of the disclosure, the ink is printed on a substrate such as a game ball, and particularly on a golf ball, and cured with visible light.

Therefore, embodiments of the disclosure are directed to a substrate, particularly a game ball or an implement used in a game, with a surface and indicium comprising an ink cured with visible light adhered to the surface. Other sports-related substrates include, but are not limited to, a baseball or cricket bat, a field hockey stick, and a crosse and a handle (together, a “stick”) for lacrosse.

The impact resistance of the ink and the adhesion between the indicium and the surface are sufficient to ensure that at least a major part of the indicium remains on the surface. When the substrate is a golf ball, for example, the major part of the indicium remains on the golf ball surface after the golf ball is struck with a club. This durability renders the ball suitable for use in competitive play.

In embodiments of the disclosure, one or more indicia can be applied directly to the cover of a one-piece, a two-piece, or a multi-piece game ball. Typically, the game ball is a golf ball. Typically, a golf ball can have between 1 and 7 layers. For convenience herein, a golf ball will be described as having 1 or 2 layers.

One or more primer coats can be positioned between the game ball cover and any indicia. Furthermore, one or more top coats can be positioned over the indicia. Typically, the ink is not cross-linked so much that the top coat does not adhere to the indicia. The indicia are sufficiently durable that at least about 50 percent, typically at least about 70 percent, and more typically at least about 80 percent of the surface area of the original image remains on the substrate after the substrate is subjected to a durability test procedure. For example, a golf ball could be subjected to a wet barrel durability test procedure.

Any suitable durability test can be used to evaluate embodiments of the disclosure as compared with other inks. For example, for a game ball, particularly golf balls, a wet barrel durability test or a plate or club impact test may be suitable. The wet barrel durability test is performed by first soaking (immersing) the test golf balls in water for at least 3 hours. Thereafter, each ball is fired 100 times at a velocity of 134 ft/sec at 72° F. into a five-sided container, the walls of which are steel plates that have had grooves milled therein to simulate the grooves present on a golf club face. The balls are then examined for adhesion of the ink. A plate impact durability test procedure involves propelling a ball at a speed that represents a typical speed of impact for the sport at an essentially non-yielding plate for a fixed number of times before evaluation. Alternatively, golf balls, for example, could be struck with a club at typical club head speed for a fixed number of times before evaluation.

Similar test procedures could be used for a bat. For example, a bat would be swung at a representative speed to hit a ball a fixed number of times. Other substrates, such as a crosse, could be tested by bending or striking the substrate in the area of the indicium in a typical manner a fixed number of times. These and other suitable tests are known to the skilled practitioner. With the guidance provided herein, the skilled practitioner will be able to develop and implement a suitable durability test procedure.

In embodiments of the disclosure, ink is cured with only visible light. The ink composition consists essentially of a free-radical polymerizable resin, a self-initiated visible light photoinitiator for initiating polymerization of the resin cured with visible light, and typically includes a coloring agent, such as a pigment, a dye, and a combination thereof. The ink has a Sward hardness (ASTM D 2134-66) of no more than about 40 after curing is complete and has adhesive properties and impact resistance sufficient to render it suitable for use on a game ball to be used in competitive play. A thinning agent selected from the group consisting of a monomer, a solvent, or a blend thereof, typically also is included. A wetting agent and/or extender pigment also can be added. To facilitate pad transfer, in embodiments of the disclosure, the ink composition has a viscosity of between about 50 centipoise and about 15,000 centipoise, typically between about 100 centipoise and about 10,000 centipoise, and more typically between about 200 centipoise and about 5,000 centipoise at the time of application.

A method of applying an indicium to a substrate comprises the steps of (a) obtaining an ink composition curable with visible light consisting essentially of a self-initiated visible light photoinitiator and a free-radical polymerizable resin, optionally containing a coloring agent, such as a pigment, a dye, or a combination thereof, the ink composition having a viscosity of between about 50 centipoise and about 15,000 centipoise, and typically between about 100 centipoise and about 10,000 centipoise, (b) applying the ink composition to the game ball in the form of the indicium, (c) curing the ink composition by exposure to intense visible light to form a cured ink film having a Sward hardness (ASTM D 2134-66) of no more than about 40, and (d) optionally applying a coating over the cured ink film. The indicium has impact resistance sufficient to render the game ball suitable for use in competitive play. The ink composition typically is applied by pad printing. The step of curing with visible light typically includes placing the indicium under a visible light lamp at conditions of lamp intensity, light wavelength, lamp distance, and time sufficient to commence curing of the ink. Curing typically is substantially complete within about 1 second. The light can be directed at the surface of the ball directly or by way of a suitable reflector, such as a parabolic reflector, which can be used to intensify the light on the indicium. With the guidance provided herein, the skilled practitioner will be able to select a suitable irradiation technique and the equipment required to carry it out.

The disclosure accordingly comprises the several steps and the relation of one or more of such steps with respect to each of the others and the article possessing the features, properties, and the relation of elements exemplified in the following detailed disclosure.

The ink composition curable with visible light of the present disclosure is unique in that it exhibits a combination of favorable transfer properties and good durability or impact resistance. The ink composition can be used for printing indicia on various substrates, such as game balls. In particular, the substrates have ionomeric resin surfaces, such as golf balls, softballs, baseballs, and other game balls. The ink composition also can be used on other substrates, such as polybutadiene, synthetic leathers based on polyurethane or polyvinyl chloride, and other substrates.

Embodiments of the ink composition disclosed herein consist essentially of a free-radical polymerizable resin and a self-initiated visible light photoinitiator, typically combined with a coloring agent, such as a pigment, a dye, or a combination thereof. A thinning agent selected from the group consisting of a monomer, a solvent, or a blend thereof, also can be added to adjust viscosity to the typical range. Also, a wetting agent also can be included as an aide to ensuring that the ink composition properly forms the indicium and adheres to the substrate.

Embodiments of the disclosure include free-radical polymerizable resin that typically comprises an oligomer. Non-limiting examples of the oligomer include one or more epoxies, acrylics, acrylated urethanes, elastomeric acrylates, unsaturated polyesters, and polyethers. Specific examples of suitable oligomers include methacrylates such as bisphenol A ethoxylate dimethacrylate and acrylated epoxies.

Blends of different oligomers can be used in embodiments of the disclosure. The oligomer typically is present to provide the ink with properties and characteristics, particularly flexibility and impact resistance, sufficient to withstand the conditions to which the substrate is to be subjected. For example, if the substrate is a golf ball, the oligomer is chosen to impart to the cured ink more flexibility than is inherent in the underlying substrate. In this way, the indicium can flex at least as much as the substrate and is less likely to be dislodged from the substrate. When a top coat is to be placed over the ink, the cured ink should not be so highly cross-linked that adhesion of the top coat to the cured ink of the indicium is substantially hindered.

In embodiments of the disclosure, the oligomer typically comprises about 10 wt percent to about 90 wt percent of the ink composition, based on the total weight of the ink composition, more typically between about 20 wt percent and about 80 wt percent oligomer, and most typically between about 50 wt percent and about 70 wt percent oligomer, based on the total weight of the ink composition.

Embodiments of the disclosure also may comprise a coloring agent. The coloring agent can be any type of pigment, dye, combination thereof, or the like which will withstand the visible light used to cure the ink composition. That is, the coloring agent typically is not labile in visible light of the wavelength used to cure the resin. Furthermore, the coloring agent should permit sufficient passage of curing light through the ink, by any combination of transmission, reflection, or refraction mechanisms, to initiate photocrosslinking.

In embodiments of the disclosure, liquid or powder coloring agent can be used. One typical form of the ink composition is a powder dispersed in liquid monomer. Carbon black and iron oxide black are non-limiting examples of suitable pigments for making black inks. Blends of different pigments, blends of dyes, and blends of pigments and dyes can be used. Embodiments of the disclosure of the ink composition typically contain between about 2 wt percent and about 60 wt percent of pigment, based on the weight of the ink composition. More typically, the ink composition comprises between about 5 and about 30 wt percent pigment, and most typically between about 5 and about 10 wt percent pigment, based on the weight of the ink composition.

The self-initiated visible light photoinitiator is selected to respond primarily to the wavelength of the visible light used for photoinitiation in embodiments of the disclosure. It is also important to consider the color of the ink in selecting the photoinitiator because, as indicated above, it is necessary for the curing light to penetrate in the ink composition to initiate the cure. More specifically, penetration is required in order to cure that portion of the ink composition beneath the surface.

UV penetration typically is most difficult when black or white pigments are used because both carbon black and titanium dioxide, both components of pigments, are excellent absorbers of UV radiation. On the other hand, visible light is able to penetrate more easily. Non-limiting examples of self-initiated visible light photoinitiators to be used in embodiments of the disclosure in conjunction with black pigment include sulfur-type self-initiated visible light photoinitiators such as isopropyl thioxanthone, and benzophenone and its derivatives, including acetophenone types and thioxanthones. The self-initiated visible light photoinitiator also may be a free-radical initiator, such as a peroxide, activated by visible light.

There exist two general classes or types of photoinitiators. Typically, these two types are known as “a-cleavage” (Type I) initiators and “hydrogen-abstraction” (Type II) initiators. Type II initiators are more typically used with visible light photoinitiation, particularly in the visible light spectral region adjacent UV light. Typically, Type II photoinitiators are selected from the group consisting of benzophenones and derivatives thereof, thioxanthones (TX) and the thiol and carboxylic acid derivatives thereof, benzil, quinones, and blends thereof. Alcohols, ethers, amines, and thiols often are used as hydrogen donors. In particular, TX derivatives, in conjunction with tertiary amines, are efficient photoinitiators with absorption characteristics that compare favorably with benzophenones.

The inventor has discovered that co-initiators are not necessary. Although the inventor does not wish to be bound by theory, it is believed that tertiary amine co-initiator is not necessary when sufficient hydrogen abstraction may be obtained from the self-initiated visible light photoinitiator, as is done in embodiments of the disclosure. Eliminating the co-initiator not only saves formulation cost but also allows the ink to have better color when cured because many co-initiators are so strongly colored that they impart a color to the ink. Thioxanthone-based 9-(2-morpholine-4-yl-acetyl)-5-thia-naphthasen-12-one (TX-MPM) is one such TX derivative that serves as a self-initiated visible light photoinitiator.

Further, thiol and carboxylic acid derivatives of TXs have been reported to initiate photopolymerization without co-initiators because they contain hydrogen-donating functionality. Camphorquinone (C₁₀H₁₄O₂—CAS 10373-78-1) is one such derivative. Camphorquinone, which has a peak absorbance at 470 nm, can initiate, albeit slowly, free radical polymerization under blue light (wavelength between about 400 nm and about 500 nm).

A photoinitiator that introduces both chromophoric and hydrogen-donating groups into polymer chains ameliorates these issues, and so may be useful in embodiments of the disclosure. Similarly, a TX-based photoinitiator having an anthracene group, which photoinitiator does not require an additional hydrogen donor for free radical formation, is known to polymerize acrylate monomers and styrene monomers in the presence of air and is suitably used. Environmentally-sensitive free radical photoinititators, such as thioxanthone-fluorene carboxylic acid (oil soluble) and its sodium salt (water soluble), which are efficient in visible light, also are suitable. With the guidance provided herein, the skilled practitioner can select a suitable self-initiated visible light photoinitiator.

In particular, thioxanthone-based 9-(2-morpholine-4-yl-acetyl)-5-thia-naphthasen-12-one (TX-MPM) and camphorquinone typically are used as a self-initiated visible light photoinitiator in embodiments of the disclosure.

The ink composition typically contains between about 0.3 wt percent and about 5 wt percent photoinitiator, more typically between about 1 wt percent and about 4 wt percent photoinitiator and most typically between about 3 wt percent and about 4 wt percent photoinitiator, based on the weight of the ink composition. Blends of different photoinitiators can be used.

The elimination of a co-initiator from the ink formulation of embodiments of the disclosure is important for several reasons. An important reason is that the co-initiator typically imparts color to the ink. This is deleterious to both the final color of the ink and the durability of the ink when the ink is exposed to UV radiation, such as sunlight. These drawbacks also apply to UV-curable photoinitiator, which, like co-initiator, will discolor and tend to degrade the composition. Further, conventional UV-photoinitiators and amine/hydrogen donors (co-initiators) also may present regulatory issues and sometimes are malodorous.

The inventor has discovered that elimination of UV photoinitiator from known combinations including both UV and visible light photoinitiators allows for improved flexibility in formulation and processing. For example, many processing steps are changed when visible light photoinitiator is used. Irradiation with UV light creates ozone and heat that must be removed from the workplace. Further, the UV light itself is intense and is subject to regulation in the workplace, including shields to ensure that UV irradiation does not escape. Also, it is periodically necessary to check the strength and wavelength of UV irradiation by passing a calibration-checking device through the UV irradiation, thus disrupting production. Adjustment to the strength and wavelength then may be required. UV bulbs often need replacement.

In contradistinction, visible light from diodes seldom needs calibration, does not produce as much heat, and does not generate ozone. Diodes also have long service life.

Processing also can be more flexible using visible-light curing because visible light will pass through many clear top coatings without adversely affecting the coating and without significant loss of curing energy. This enables a manufacturer to apply an indicium and apply a clear, non-absorbing top-coat over the indicium. In this way, the indicium can be cured through a top coat after the top coat is applied.

The ink of embodiments of the disclosure cured with visible light may also contain moieties that are water labile or soluble. Incorporating these moieties into the cured ink allows for ease of recycling the substrate, such as golf balls, at the end of their useful life. Although the inventor does not wish to be bound by theory, it is believed that the water labile moieties enable moisture to attack at least a part of the indicium and make the indicium more easily removable from the substrate. Such an indicium typically would be placed under a topcoat to protect it from moisture during use. Compounds that are suitable for manufacture of a water labile or soluble ink include acrylated polylactic acid oligomer.

In embodiments of the disclosure, a thinning agent is added to lower the viscosity of the uncured ink composition if desirable, or to contribute to impact resistance or flexibility. A thinning agent may be a solvent for other components of the ink composition. Alternatively, a monomer can be used as a thinning agent. The monomer thinning agent typically is a photopolymerizable monomer that forms a polymeric structure upon irradiation. In contrast, solvents evaporate during curing.

Non-limiting examples of solvents includes aromatic solvents, such as toluene and xylene, and ester-type solvents, such as butyl acetate.

In some embodiments of the disclosure, the monomer can be a monofunctional, difunctional, or multifunctional acrylate. Non-limiting examples of suitable monomers include 1,6-hexanediol diacrylate, butanediol diacrylate, trimethylol propane diacrylate, tripropylene glycol diacrylate, and tetraethylene glycol diacrylate. Typically, 1,6-hexanediol diacrylate is used as a monomeric thinning agent in embodiments of the disclosure.

Embodiments of the ink composition of the disclosure typically contain between about 10 wt percent to about 70 wt percent monomer, more typically between about 10 wt percent and about 60 wt percent monomer, and most typically between about 10 wt percent and about 55 wt percent monomer, based on the weight of the ink composition. Also, in typical embodiments of the disclosure, the combination of monomer plus oligomer constitutes about 45 wt percent to about 80 wt percent of the ink composition, based on the weight of the ink composition, more typically about 50 wt percent to about 80 wt percent, and most typically about 60 wt percent to about 80 wt percent, based on the weight of the ink composition.

In embodiments in which a solvent is used, the solvent typically is a liquid with a fast to moderate evaporation rate which, upon partial evaporation, causes the ink composition to be tacky and thereby promotes transfer onto and off of an ink pad. Solvent also can be the medium in which photoinitiator is dissolved for introduction into the ink composition. Non-limiting examples of suitable solvents include aromatic solvents such as toluene, xylene, and ester-type solvents, such as butyl acetate. When solvent is present, the ink composition typically includes about 1 wt percent to about 30 wt percent solvent, more typically about 5 wt percent to about 20 wt percent solvent, and most typically about 8 wt percent to about 10 wt percent solvent, based on the weight of the ink composition.

Extender pigments such as talc, barium sulfate, and the like can be added in embodiments of the disclosure as long as sufficient durability is maintained. Such materials may be used to improve transferability. Typically, if such materials are used, they constitute about 10 wt percent to about 40 wt percent, or more typically about 20 wt percent to about 30 wt percent, based on the weight of the ink composition.

The surface tension of the ink composition affects pad transfer. The surface tension of the ink composition should not be substantially higher than the surface tension of the substrate upon which it is printed. The viscosity of the ink composition will determine the thickness of the indicium on the cover. If the indicium is too thick, the visible light radiation may not penetrate the indicium and complete curing may become difficult. On the other hand, if the indicium is too thin, the durability of the ink layer may be insufficient for conditions of play. The indicium has a thickness of less than about 100 microns, typically about 10 microns to about 40 microns, more typically about 13 microns to about 30 microns, and most typically about 20 microns to about 25 microns.

In selected embodiments, wetting agents can be added if necessary to prevent beading of the ink composition upon application to the substrate, such as upon the surface of a golf ball. Suitable wetting agents include, but are not limited to, silicon surfactants and fluorocarbon surfactants. The ink composition typically includes about 0 wt percent to about 2 wt percent wetting agent, based on the weight of the ink composition. Other additives that do not adversely affect the pad transfer and impact resistance of the ink composition also can be incorporated into the ink composition.

The cured ink should be sufficiently flexible that it exhibits good impact resistance. In embodiments of the disclosure, it is advantageous for the top coat, which is applied over the ink, to react with the ink to aid in holding the ink in place, or to have adhesion by hydrogen bonding and/or Van Der Waals forces. As a non-limiting example, the ink can be used in conjunction with a two component polyurethane top coat, such as a top coat based on polyester or acrylic polyols and aliphatic isocyanates, such as hexamethylene diisocyanate or isophorane diisocyanate trimers.

In embodiments of the disclosure, a top coat typically is applied over the indicia to protect the indicia unless the indicia have sufficient adhesion to the surface to which they are applied, for example the cover or a primer layer, to render the use of a top coat unnecessary. The adhesion between the ink and the top coat and/or substrate should be sufficiently strong that the indicia remain substantially intact when the game ball is used. Standards for image retention vary depending upon the intended use of the game ball and the degree and frequency of impact that the image is required to withstand. When applied to a golf ball, the ink durability should be sufficient in order that after the ball is subjected to the wet barrel durability test procedure described below, at least about 50 percent of the surface area of the original image remains, more typically at least about 70 percent, and most typically at least about 80 percent.

Embodiments of a formulation of ink cured with visible light of the disclosure for golf ball printing are prepared and used in the following way. The photoinitiator is dissolved in the thinning agent, which is then mixed with oligomer and pigment. The mixture is placed in an open or closed cup dispenser of a pad printing device.

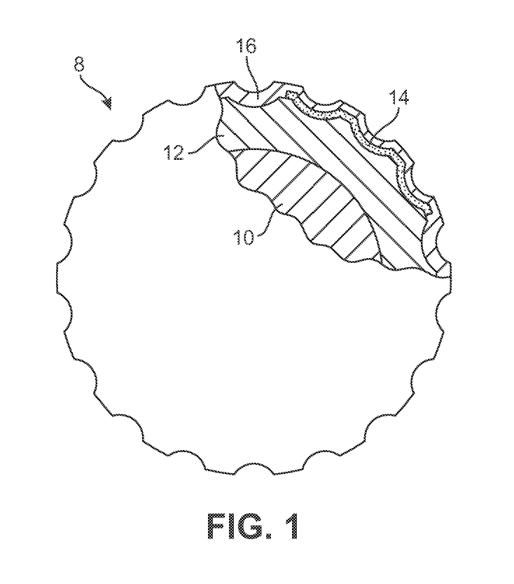

In some embodiments of the disclosure, a primed but unfinished golf ball is obtained. Ball 8 in FIG. 1 includes, for example, a core 10, and a durable cover layer 12 having a dimpled surface. Alternatively, the core and cover can be formed in one piece. These layers are representative of an unfinished golf ball.

In some embodiments of the disclosure, an unfinished golf ball is made by forming a core 10 and then forming a durable cover layer 12 essentially surrounding the core 10. Alternatively, a one-piece golf ball is formed with a durable cover layer 12. An indicium is pad printed on golf ball cover layer 12. The ink indicium can either be stamped directly on cover layer 12 or can be stamped on a primer which is placed over cover layer 12. The unfinished golf ball with uncured ink composition thereon then is subjected to visible light treatment under conditions sufficient to commence curing of the ink composition to form cured indicium 14. After photoinitiation, curing of the ink is substantially complete within a period of between about less than one second and about a few seconds.

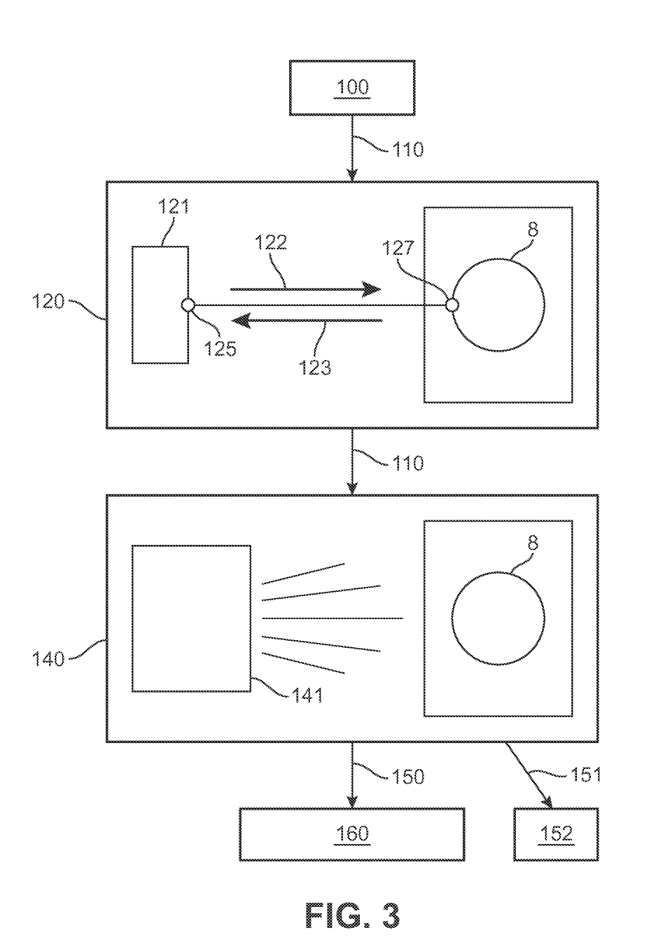

FIG. 3 illustrates a schematic flow diagram for a method of the disclosure. Ball 8 (not shown) is formed at 100 in accordance with disclosure herein. Ball 8 is moved in the direction of arrow 110 to printing station 120. Pad 121 in position 125 first is inked, then is moved in direction 122 to contact ball 8 and deposit indicium 114 (not shown) on ball 8 at position 127. Pad 121 then is moved in direction 123 until pad 121 is restored to position 125. The pad is again inked and another ball 8 is placed at position 127, and the printing cycle is repeated. The skilled practitioner recognizes that the printing pad may comprise a rotatable disc with plural images of the indicium placed serially along the edge of the disc. The pad is rotated at a speed that matches an indicium image with a golf ball to place the ink on the golf ball as each golf ball is presented. Each image on the rotating pad is inked before again contacting a golf ball.

Ball 8 with uncured indicium 114 thereon is moved in the direction of arrow 130 to curing station 140. Due care is taken during the movement of ball 8 to ensure that uncured indicium 114 thereon is not smeared or otherwise damaged. At curing station 140, uncured indicium 114 is exposed to intense visible light from light source 141. The intense light cures the ink composition of indicium 114 to form cured indicium 14. As noted above, a reflector arrangement also can be used to intensify the light onto the indicium.

After appropriate curing conditions, ball 8 with cured indicium 14 thereon can be considered complete and is moved in the direction of arrow 151 to station 152. Alternatively, after appropriate curing conditions, ball 8 with cured indicium 14 thereon is moved in the direction of arrow 150 for further processing, such as application of a topcoat, at station 160. With the guidance provided herein, the skilled practitioner can identify alternative arrangements throughout to carry out the method of the disclosure.

In embodiments of the disclosure, the golf ball may be further processed by placing a top coat layer 16 over cured ink indicium 14. Top coat layer 16 assists in keeping the indicium on the golf ball surface, as indicated above, and therefore the adhesion of the indicium to the golf ball does not need to be as strong as would be required if the ink were to constitute the outer layer of the ball. Top coat layer 16 typically has a thickness of about 10 microns to about 40 microns.

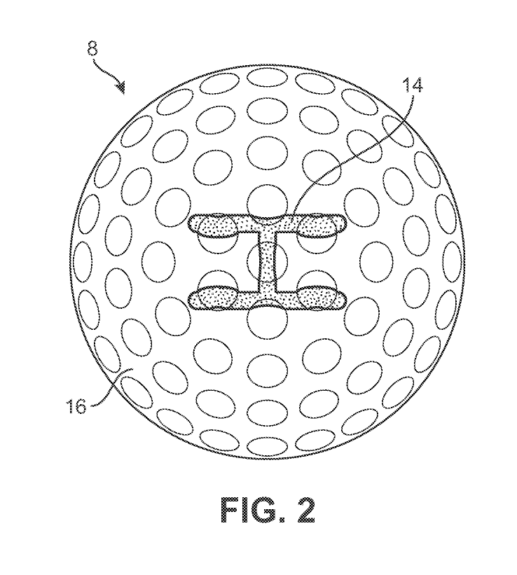

FIG. 2 illustrates golf ball 8 having indicium 14 on the surface of the cover layer covered with top coat layer 16.

The conditions of visible light exposure that are appropriate to cure the ink composition can be ascertained by one having ordinary skill in the art. For example, it has been found that when a golf ball passes through a visible light treatment apparatus at a rate of 10 ft/min. at a distance of about 1¼ inches to about 1¾ inches from a visible light source which has an intensity of at least about 500 mW/cm², more typically between about 750 mW/cm² and about 1000 mW/cm², the indicia should be exposed to visible light radiation for no more than a few seconds, typically, no more than about 1 second, and more typically no more than about 0.7 seconds. Higher and lower visible light lamp intensities may be used as long as the cured ink meets the applicable durability requirements. Excess light exposure is avoided in order to prevent degradation of the substrate. The ink composition is cured prior to application of any top coat.

In some embodiments of the disclosure, the pad to be used for transfer of the ink composition typically contains silicone. This type of pad has good elasticity, durability, and softness and an appropriate surface tension. Other types of pads also can be used.

In some embodiments of the disclosure, the ink composition can be applied on a non-light-labile surface of a substrate, such as a game ball. In accordance with the disclosure, it is generally not necessary to pretreat the surface prior to application of the ink composition. If it is desired to apply the ink composition curable with visible light on an extremely smooth surface upon which transfer is poor, the portion of the surface to be stamped can be chemically or physically etched or abraded to provide an ink-receptive surface.

The ink of the disclosure has a Sward hardness after curing of no more than 40, more typically no more than 20, and most typically no more than about 14. The ink cured with visible light of the disclosure provides for durability sufficient to meet stringent durability standards required for commercial grade golf balls. The durability of the ink can be determined by testing stamped golf balls in a variety of ways, including using the wet barrel durability test procedure.

In some embodiments of the disclosure, the visible light used to cure the ink composition typically has a peak wavelength band in the blue visible light range, whereas the wavelength range for visible light used to initiate the self-initiated visible light photoinitiator is between about 400 nm and about 700 nm. The wavelength range for blue light used in some embodiments of the disclosure is between about 400 nm and about 450 nm. In embodiments of the disclosure, blue wavelength visible light can be generated by metal halide bulbs, mercury bulbs, and LEDs, for example.

Embodiments of the disclosure typically employ LEDs because the wavelength range is narrow. For example, the Blue Wave® LED Visible Light Spot Curing System, available in the United States from DYMAX Corporation, Connecticut, USA, and worldwide at other DYMAX entities in Germany, Europe; Shenzen, China; and Kowloon, Hong Kong. This system generates light using an array of surface-mounted LEDs, thus saving electricity and operating costs and shrinking the carbon footprint as compared with a system using traditional bulbs. Not only does LED light have a narrow wavelength band centered at 410 nm, but also there is no warm-up period and there are no bulbs to change. Further, LED light has constant intensity. The system provides a maximum visible intensity of greater than about 3000 mW/cm² and intensity can be adjusted from 0 percent to 100 percent.

In embodiments of the disclosure, the intensity typically is between about 500 mW/cm² and about 3000 mW/cm², more typically between about 750 mW/cm² and about 1000 mW/cm². With the guidance provided herein, the skilled practitioner will be able to identify the correct intensity for any particular ink.

Use of visible light in embodiments of the disclosure is environmentally sensitive. Not only is power consumption lower than for UV curing, but also there is no ozone generated as there typically is with UV curing.

The following examples are included for purposes of illustration so that the disclosure may be more readily understood and are in no way intended to limit the scope of the disclosure unless otherwise specifically indicated.

### Example 1

A golf ball printing ink composition was prepared which contains the following:

| | Quantity, |
|---|---|
| Material | parts by weight |
| Aliphatic Urethane Acrylate Oligomer | 80. |
| 1,6-hexanediol diacrylate | 20. |
| Thioxanthone-based 9-(2-morpholine-4-yl- | 1.5 |
| acetyl)-5-thia-naphthasen-12-one (TX-MPM) | |

The components are blended together to form the ink composition. A silicone pad is used to transfer the ink composition to unprimed, dimpled, ionomeric covers of several dozen golf balls. The ink composition has a viscosity of 300 centipoise to 1,000 centipoise at application.

The golf balls containing the stamped indicium are passed by the light guide of a BlueWave® System using an intensity of 750 mW/cm². Cure time is between about 0.7 sec and about 1 sec. The wavelength of the light is centered at 410 nm.

The ink has a Sward hardness of 15 when cured.

The golf balls then are coated with a solvent-borne polyurethane topcoat formed from a hexamethylene diisocyanate polyester-type polyurethane.

The adhesion of the indicium on the balls is tested for durability according to the wet barrel durability test procedure described above. After wet barrel durability testing, the balls are examined and it is found that no more than about 20 percent of the surface area of the original ink logo was removed.

### Comparative Example 1

The procedure of Example 1 was repeated with the exception that a commercially available ink cured with UV light was used, namely Blk #700801 (Trans Tech, Carol Stream, Ill.). The ink had a viscosity of about 6,000 centipoise. The ink was cured in about 1 second and produced a film having a Sward hardness of about 26. After the wet barrel durability test, only the outline of the logo remained. Most of the ink in the dimples and on the land areas had been removed. Intercoat adhesion between the ink and top coat was poor.

### Comparative Example 2

The procedure of Example 1 was repeated on several golf balls with the exception that a commercially available UV cured ink was used, namely L-526-163-B (Qure Tech, Seabrook, N.H.). The ink had a viscosity of about 28,500 centipoise. The ink was cured in about 1 second and produced a film having a Sward hardness of about 20. As a result of the wet barrel durability test, the ink on at least about 60% of the surface area of the logo had been removed. It is believed that the ink was too brittle to withstand the conditions of the wet barrel durability test.

While various embodiments of the invention have been described, the description is intended to be exemplary, rather than limiting and it will be apparent to those of ordinary skill in the art that many more embodiments and implementations are possible that are within the scope of the invention. For example, a different ink oligomer; a different monomer thinner, or a solvent; or a different photoinitiator, can be used in embodiments of the disclosure. Accordingly, the invention is not to be restricted except in light of the attached claims and their equivalents. Also, various modifications and changes may be made within the scope of the attached claims.

What is claimed is:

1. A substrate having a surface and an indicium comprising an ink cured with visible light to form cured ink adhered to the surface, the cured ink being formed from an ink composition consisting essentially of a free-radical polymerizable resin and a self-initiated visible light photoinitiator that is primarily activated by light having a visible light wavelength above 400 nm, the impact resistance of the cured ink and the adhesion between the indicium and the surface after curing with visible light having a wavelength greater than 400 nm being sufficient to render the surface suitable for use in competitive play.

2. The substrate according to claim 1, wherein the substrate is a game ball.

3. The game ball according to claim 2, wherein the self-initiated visible light photoinitiator is selected from the group consisting of benzophenone and derivatives thereof; thioxanthones and thiol and carboxylic acid derivatives thereof; benzil; quinones; and blends thereof.

4. The game ball according to claim 2, wherein the game ball is a golf ball.

5. The golf ball according to claim 4, wherein at least about 50% of the surface area of the indicium is retained after being subjected to the wet barrel durability test procedure.

6. The golf ball according to claim 5, wherein the percentage retained is at least about 70% of the surface area of the indicium.

7. The golf ball according to claim 4, wherein at least about 80% of the surface area of the indicium is retained after being subjected to a durability test procedure.

8. The substrate according to claim 1, wherein the ink cured with visible light is a pad transferable ink at the time of application.

9. The substrate according to claim 1, wherein the surface to which the indicium is adhered further comprises a top coat formed over the indicium.

10. The substrate according to claim 9, wherein the adhesion of the top coat to the indicium is not hindered.

11. The substrate according to claim 1, wherein at least about 80% of the surface area of the indicium is retained after being subjected to a durability test procedure.

12. The substrate according to claim 1, wherein the ink composition has a viscosity of between about 50 centipoise and about 15,000 centipoise at the time of application.

13. The substrate according to claim 12, wherein the ink composition has a viscosity of between about 100 centipoise and about 10,000 centipoise at the time of application.

14. The game ball according to claim 13, wherein the ink cured with visible light comprises between about 10 wt percent and about 90 wt percent oligomer.

15. The game ball according to claim 13, wherein the ink composition contains between about 2 wt percent and about 60 wt percent coloring agent and between about 1 wt percent and about 4 wt percent photoinitiator.

16. The substrate according to claim 11, wherein the ink composition contains sufficient quantity of photoinitiator to permit the ink to cure within a few seconds upon exposure to visible blue light having a peak wavelength between about 400 nm and about 450 nm.

17. A game ball having a surface and an indicium adhered to the surface, the indicium being formed from an ink composition cured with visible light, comprising:
a free-radical polymerizable resin,
a coloring agent, and
a self-initiated visible light photoinitiator that is initiated with visible light having a wavelength between about 400 nm and about 700 nm,
the ink composition having a viscosity at the time of application of between about 100 centipoise and about 10,000 centipoise, the ink having a Sward hardness (ASTM D 2134-66) of no more than about 40 after curing, the adhesive properties and impact resistance of the ink after curing rendering the ink suitable for making an indicium on a cover of a game ball to be used in competitive play.

18. The game ball of claim 17, wherein the game ball is a golf ball.

19. A method for printing an impact-resistant indicium on a game ball, the method comprising:
providing a game ball precursor having a substrate surface for printing;
applying an ink composition consisting essentially of ink curable with visible light and a self-initiated visible light photoinitiator to an ink transfer pad;
transferring the ink composition from the pad to the substrate surface of the game ball to form an uncured indicium consisting essentially of ink curable with visible light and a self-initiated visible light photoinitiator;
irradiating the uncured indicium with visible light for a time and at an intensity sufficient to cure the ink and render the surface suitable for competitive play.

20. The method of claim 19, further comprising applying a protective top coating to the game ball.

21. The method of claim 19, wherein the game ball is a golf ball having between 1 and 7 layers and the cover layer provides a substrate surface suitable for printing.
